(19) United States
(12) Patent Application Publication
(10) Pub. No.: US 2011/0200791 A1
(43) Pub. Date: Aug. 18, 2011

(54) METHOD FOR PRODUCING A COMPOSITE PART BY TRANSMISSION LASER WELDING

(75) Inventors: Franz Kugelmann, St. Wendel (DE); Tobias Weber, St. Wendel (DE)

(73) Assignee: GANGNAM CHICAGO DENTAL CLINIC 3F, SEOUL (KR)

(21) Appl. No.: 13/057,494

(22) PCT Filed: Aug. 4, 2009
(86) PCT No.: PCT/EP2009/005638

§ 371 Date: Apr. 5, 2011

(30) Foreign Application Priority Data
Aug. 5, 2008 (DE) 10-2008-036-467.3

(51) Int. Cl. B32B 3/10; B32B 27/32; B32B 37/06

(52) U.S. Cl. 428/172; 428/523; 428/339; 428/521; 156/272.8

(57) ABSTRACT

The present invention relates to a method of producing a composite by transmission laser welding, comprising the steps: a)flat arrangement of a multilayer film (2), which has a joint layer, on a hard plastic part (1) such that the joint layer abuts the hard plastic part (1), wherein the joint layer contains an absorber for laser light, b) pressing of the multilayer film (2) against the hard plastic part (1) with a pressure tool (4) permeable for laser light, and c) irradiation of the array obtained in step b) with laser light from the multilayer film (2) side, a composite obtainable with the method and a composite-welding array which is used in the method.

The present invention relates to a transmission laser welding method for welding a hard plastic element to a multilayer film, a composite that can be obtained thereby and a composite-welding array which is used in the method.

In principle, various possibilities exist for positively connecting shaped parts made of plastics, in particular of differing plastics. For example, two shaped parts can be connected positively to each other by means of adhesive bonding or welding methods.

Of the welding methods, in addition to IR welding (see, for example, WO 2005/080067) welding by means of laser radiation has recently been examined particularly intensively.

The fundamental physical principle of a welding method by means of laser requires that at least a portion of the applied laser light be absorbed by the material of at least one of the two shaped parts to be connected to each other, at least to such an extent that it can be converted into heat and the material at the site heated by the laser light becomes fluid through heating and renders possible a positive connection to the plastic material of the second shaped part.

A special form of the laser welding method, namely, the transmission laser welding method, has the advantage, in comparison with other welding methods, that even complex geometries of the joint surface can be welded rapidly and efficiently. It is necessary when welding for one joint partner to be irradiated all the way through by the laser beam, i.e. for laser radiation not to be absorbed. The second joint partner or parts of the second joint partner must be capable of absorbing the laser light with the generation of heat. The irradiation is usually effected from the outside of a joint partner.

Parameters limiting the welding method are the wavelength of the laser light used and the absorption behaviour of the plastic at this wavelength. In particular, in this case high-power diode lasers having a wavelength of 610-840 nanometres and Nd:YAG solid-state lasers having a wavelength of approximately 1,050 nanometres are used either in the visible light range (400-750 nanometres) or in the infrared range. However, it is also possible to use CO₂ gas lasers having a wavelength of approximately 11,000 nanometres.

The absorption characteristics, and therefore the processing, of plastics differ greatly in dependence on the laser radiation wavelength used. Inhomogeneities in the plastic, such as, for example, pigments, fillers or reinforcing materials, but also crystalline superstructures in the case of partially crystallizing plastics, scatter the input radiation and reduce in particular the depth of penetration of the radiation into the plastic.

When a laser beam is incident upon a plastic part to be heated, the laser radiation is reflected, absorbed and transmitted to differing extents. The decrease in intensity of the radiation penetrating into the plastic can be described, in dependence on the material depth, according to the so-termed Bouguer's law. In this case, the input intensity decreases exponentially with the material depth.

Problems occur particularly as a result of the thermal decomposition resulting from radiation heating of plastics, in particular by means of CO₂ lasers. This has to do with the poor thermal conductivity of plastics, since the surface temperature of the plastic part often increases rapidly, wherein there is the risk of thermal material decomposition. [The principles of laser welding methods are described, for example, in H. Potente et al., “Laserschweiβen von Thermoplasten” (Plastverarbeiter 1995, no. 9, p. 42 ff), F. Becker et al., “Trends bei Serienschweiβverfahren” in Kunststoffe 87 (1997, p. 11 ff) and by H. Puetz et al. in Modern Plastics, (1997, p. 121 ff).]

The absorption behaviour, and therefore also the transmission, of a polymer or plastic that is laser-transparent at a certain wavelength can be controlled, for example, through the admixing of absorbers. Such absorbers are, for example, carbon black and also special dyes that have been developed in recent years.

A series of dyes that render possible such a controllable absorption behaviour are commercially available, and have been specially developed to be admixed to polymer mixtures in order to render possible laser welding at defined wavelengths. Also available for this purpose are the dyes disclosed by I. A. Jones et al. in “Use of infrared dyes for Transmission Laser Welding of Plastics” (Tech 2000 Conference Proceedings, p. 1166 ff.).

In principle, there are several possibilities for incorporating the abovenamed absorbers into the joint partners to be welded, such as e.g. into a film and into a hard plastic part.

As a first possibility, the absorber is added to the hard plastic part. During welding, the laser beam is directed from the film side onto the array of film and hard plastic part. The laser penetrates the laser-light-permeable film and then strikes the hard plastic part. The hard plastic part contains the absorber and creates a welded joint with the film with formation of heat. However, the presence of the absorber in the hard plastic part results in the following disadvantages. The absorber must be admixed to the hard plastic part during the production of the hard plastic part, in the case of hard plastic parts that are larger and/or have a more complex shape, a large quantity of absorber must be used, and depending on the method of producing the hard plastic part the absorber is perhaps distributed inhomogeneously in the hard plastic part, with the result that during welding different welding temperatures with corresponding different material quality result.

A further possibility is to apply the absorber as a functional coating between the hard plastic part and the film, such as e.g. with a printing method. Here also the problem can arise that the absorber is applied inhomogeneously by the printing method. Furthermore the imprinted layers are sensitive and can be damaged in a production process. Both can lead to differing material quality through resultant inhomogeneous weld seams.

Alternatively, the absorber can also be admixed to the film in order to generate the required temperature during transmission laser welding. The problem arises that the absorber, which is distributed homogeneously in the film, generates heat at all sites of the irradiation zone. The heating and “melting” of the film thus takes place not only in the joint area of the film, but also on the opposite side of the film which is pressed by a pressure tool, which can result in the film sticking to the pressure tool. As the film is melted over the whole of its irradiation cross-section, furthermore the dimensional stability of the film no longer obtains, which can mean that the film, which may lie on the hard plastic part under tensile stress, is thinned. Furthermore, the welding zones can bleed as a result and lead to a poorer weld seam quality. As the absorber is distributed homogeneously in the film, the problem also arises that the heat development due to the laser beam can become too great and a pitted burn can occur. The abovenamed problems can be avoided by setting the concentration of the absorber in the film at a low value. However, this can mean that, depending on the plastic used for the film, the heat development of the film in the joint area is no longer sufficient to achieve a complete weld.

With regard to the abovementioned comments, by “melting” of the film here is meant, not a thermodynamic melting in the sense of a phase transition, but the process of softening of the film and achieving a plastic processing potential under the welding conditions. The term “melting” can also include the thermodynamic melting of partially crystalline polymers in the film composite.

WO 02/092329 A1 describes a method of laser-welding a film to a hard plastic part, in which in order to generate a contact pressure on the film a glass or plastic sheet is used and the film and the glass or plastic sheet are permeable to the laser light used and the plastic part is laser-opaque.

EP 0 472 850 A2 describes a laser-welding device with which a cover film is welded to a plastic container as hard part, wherein the cover film is pressed mechanically against the plastic container with a pressure tool and the pressure tool has a window through which the laser light used passes. The cover film is permeable for the laser light used and the plastic container is laser-opaque.

WO 01/80997 A1 relates to a method for producing plastic sheets with a plurality of recesses, in which a film and a plastic sheet are welded with laser light, wherein a material which has IR absorption properties is incorporated into the plastic sheet.

WO 2005/102588 describes a method of laser welding which comprises arranging a first workpiece adjacent to a second workpiece, wherein the first workpiece has a non-uniform thickness, furthermore comprises the arrangement of a compensation sheet adjacent to the first workpiece such that the combined thickness of the first workpiece and the compensation sheet is substantially uniform, and the laser welding of the first workpiece and of the second workpiece. The first workpiece is transparent for the laser light used and the second workpiece is laser-opaque.

The object of the present invention is therefore to provide a method of producing a composite by transmission laser welding which does not have the abovenamed disadvantages of the methods of the state of the art. Furthermore, according to the invention a composite obtainable with the method and a composite-welding array which is used in the method are to be provided.

The object is achieved by a method comprising the steps:
a)flat arrangement of a multilayer film, which has a joint layer, on a hard plastic part such that the joint layer abuts the hard plastic part, wherein the joint layer contains an absorber for laser light,
b)pressing of the multilayer film against the hard plastic part with a pressure tool permeable for laser light, and
c)irradiation of the array obtained in step b) with laser light from the multilayer film side.

With the method according to the invention, a multilayer film with a joint layer which contains an absorber for laser light is used as film. Through the use of the absorber-containing joint layer the welding heat is produced essentially only in the joint layer and in the surface area of the hard plastic part abutting the joint layer. As a result, the multilayer film retains its dimensional stability, because only part of the multilayer film is melted by the laser light absorption of the absorber. In this way, a thinning of the film or a bleeding of the welding seams is avoided.

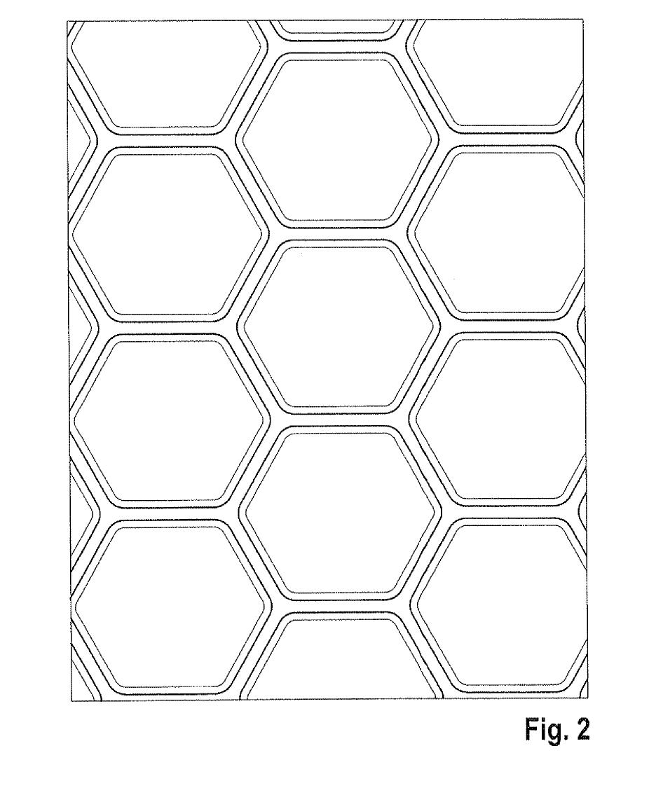

Surprisingly, the film remains dimensionally stable during welding according to the method according to the invention. In other words even complex embossed structures of a film to be welded remain unchanged despite the exposure to laser radiation (see e.g. FIG. 2).

When using the multilayer film in the present method the situation can arise that if the hard plastic part does not have a completely flat and even surface, due to the relative rigidity of the multilayer film there is no positive contact between multilayer film and hard plastic part in all areas.

This can be the case for example if no high demands are placed on the material tolerances of the hard plastic part or if a profiled hard plastic part surface is to be welded to a film. As a result, a reduced welding-seam quality is obtained during welding.

In a preferred embodiment of the method according to the invention, the method therefore also comprises the step of the flat arrangement of a flexible plastic part between the multilayer film and the pressure tool. The flexible plastic part has the property of adapting to the contours and surface unevenness of the hard plastic part and of pressing the multilayer film against the contours and surface unevenness of the hard plastic part under the contact pressure of the pressure tool. The multilayer film thereby has an improved welding contact, with the result that a better welding-seam quality is obtained.

In a further preferred embodiment of the method according to the invention, the flexible plastic part is produced from a silicone rubber which is sufficiently permeable for the wavelength of the laser used.

In a further preferred embodiment of the method according to the invention the pressure tool is a glass sheet permeable for laser light.

The multilayer film preferably has an embossed structure, in particular a hexagonal embossed area.

The method is advantageously carried out under protective gas in order to avoid a pitted burn from occurring during the laser welding.

The composite obtainable with the method described above comprises according to the invention a hard plastic part and a multilayer film, wherein the multilayer film has a joint layer which contains an absorber for laser light, and wherein the multilayer film is connected or fused flat to the hard plastic part such that the joint layer rests on the hard plastic part.

The invention is explained in more detail with reference to embodiment examples in the following figure, without this being intended to be understood as a limitation of the inventive concept.

There are shown in:

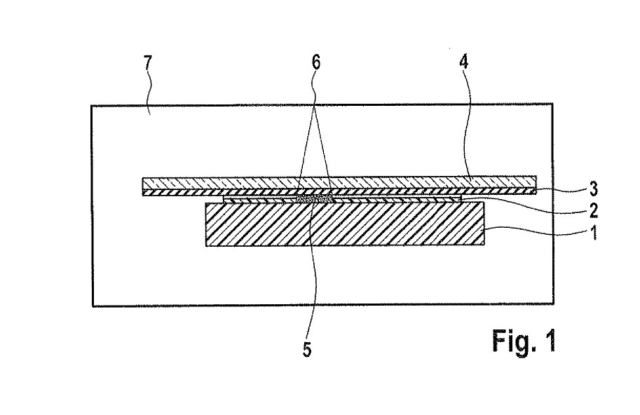

FIG. 1 a schematic representation of a composite-welding array according to the invention and

FIG. 2 an enlarged view of an embossed structure of a welded multilayer film.

An embodiment of the method according to the invention, of the composite obtainable with the method and the composite-welding array according to the invention is explained below with reference to FIGS. 1 and 2.

According to FIG. 1, a composite-welding array is formed according to one embodiment of the invention from a hard plastic part 1, a multilayer film 2 arranged flat on the hard plastic part 1, a flexible plastic part 3 arranged flat on the multilayer film 2 and a pressure tool 4.

Any weldable thermoplast which is sufficiently thermodynamically compatible in the welding with a corresponding piece of film can be used as plastic for the hard plastic part 1. The hard plastic part 1 is preferably formed from polypropylene. Further suitable materials are e.g. polyethylene, polyisoprene, polyethylene terephthalate (PET), polycarbonate, their blends and copolymers thereof.

The multilayer film 2 is composed of at least 2 layers, wherein one of the two outer layers is a joint layer. The joint layer rests on the hard plastic part 1 in the composite-welding array shown in FIG. 1. Naturally, further layers can also be present, depending on the function of the film (a so-called called “layer composite”). The formulation of the joint layer is matched to the material of the hard part in terms of weldability. The joint layer usually has a smaller layer thickness than the support layer in order that the temperature development is allowed to take place as far as possible only in the vicinity of the welding zone. Joint layers that are too thick introduce too much heat into the whole film composite during irradiation. The dimensional stability of the film composite can thereby be jeopardized.

It is conceivable for the joint layer to have only a tenth of the thickness of the second layer or of the rest of the layer composite. But ratios of less than 1:5 or less than 1:3 are also conceivable. A ratio of 1:1 can be preferably chosen if the layer composite or the further layer has comparatively high-melting further layers in addition to the joint layer. This can be the case e.g. in the case of a composite made of polypropylene (PP) as joint layer and polyamide as support layer. Polyethylene terephthalate (PET) can e.g. also be used instead of polyamide.

In a preferred embodiment, which can be used in particular in medical technology, the joint layer has a thickness of 10-100 pm consisting predominantly of 95-100% of a polypropylene without incorporation of the absorber. However, depending on the welding array, different polymer blends are possible for the formulation of the joint layer. Non-limiting examples are polymers or copolymers of C₂-C₁₀ monomers such as polyethylene, polypropylene, polyisoprene, and butadiene, olefinic styrene block copolymers with block copolymers of styrene etc., which are commercially available e.g. under the trade names KRATON® G 1652, KRATON® G 1657, KRATON6G1726, KRATON®FG 1901 and KRATON®FG 1924.

The joint layer contains an absorber for laser light which absorbs the laser light irradiated into the multilayer film 2 and thereby leads to the heating of the joint layer and the areas abutting it of the hard plastic part 1 and the multilayer film 2.

So-called IR absorbers can be used for example as absorbers. These absorb in the IR region, thus appear transparent in the visible region, which is advantageous in particular when using the film in medical technology.

Lumogen IR 788 from BASF is preferably used as absorber. The quantity of absorber present in the joint layer is generally up to 500 ppm, preferably 20-100 ppm. But other absorbers which absorb in the IR region can also be used. Lumogen IR 788 from BASF has an absorption maximum at 788 nm.

Accordingly, in this case a diode laser with a wavelength of 808 nm is chosen as laser with the closest emission wavelength.

For absorbers which are to absorb in the 940 to 960 nm region, e.g. a neodymium-doped yttrium-aluminium-garnet laser (Nd-YAG laser) is chosen.

The multilayer film 2 has an embossed structure, in particular a hexagonal embossed area, in one embodiment. One example of a hexagonal embossed area of a welded multilayer film is shown in FIG. 2. The flat multilayer film area is to assigned to the welding seam formed. It can be seen that, despite the heating when carrying out the welding method, the embossed area of the film remains intact, which shows that the multilayer film remains dimensionally stable during welding in the method according to the invention.

A silicone rubber which is permeable for the laser light used is preferably used as material for the flexible plastic part 3 which is used according to a preferred embodiment. In particular a so-called silicone mat is used as silicone rubber. This usually has a Shore hardness of Shore A=30 to 70. The thickness of such a mat is >1 mm, preferably 5 mm. Further thicknesses can be achieved, e.g. 8 mm, 6 mm, 10 mm. Air cushions or cushions filled with liquid can also be used. However, other flexible plastics can also be used, provided they are permeable for the laser light used.

A glass sheet which is made of a glass which is permeable for the laser light used is preferably used as a pressure tool 4.

The contact pressure which the pressure tool 4 exerts on the multilayer film 2 or the flexible plastic part 3 is preferably in the range from 0.1 to 2 N/mm².

The laser light used is preferably generated by a diode laser and has a wavelength of in particular 808 nm. In particular, a Diodenlaser Laserline LDF 1000-500 diode laser from Laserline GmbH is used. According to FIG. 1, the irradiated laser light 6 creates a welding zone 5 in which the plastics of the joint layer of the multilayer film 2 and of the hard plastic part 1 are melted locally. After cooling of the welding zone, the multilayer film 3 and the hard plastic part 1 are welded fast to each other.

To carry out the transmission laser welding method according to the invention, the composite-welding array shown in FIG. 1 is preferably arranged in a protective-gas atmosphere 7, whereby the occurrence of a pitted burn during welding can be reliably prevented.

The following advantages can be realized through the method according to the invention in which the composite-welding array described above is used.

Because of the presence of the absorber in the joint layer of the multilayer film, a defined welding is possible without a large part of the multilayer film experiencing a softening, as the temperature input is locally limited. Prefabricated structures in the film, such as e.g. an embossed area, surprisingly remain (FIG. 2). Through the use of the flexible plastic part it is furthermore possible according to the invention to carry out a welding not only on even hard plastic part surfaces but also on uneven and slightly curved surfaces, wherein viscous multilayer films can also be used for the welding. Thus only small demands are placed on the tolerances of the joint partners. Furthermore, an almost particle-free joining is possible and there is no weld bleeding at the edge of the welding seam.

Accordingly, a visually and mechanically acceptable welding seam can be obtained with the method according to the invention.

1. Method of producing a composite by transmission laser welding, comprising the steps:
a)flat arrangement of a multilayer film (2), which has a joint layer, on a hard plastic part (1) such that the joint layer abuts the hard plastic part (1), wherein the joint layer contains an absorber for laser light,
b)pressing of the multilayer film (2) against the hard plastic part (1) with a pressure tool (4) permeable for laser light, and
c)irradiation of the array obtained in step b) with laser light from the multilayer film (2) side.

2. Method according to claim 1, which comprises furthermore between steps a) and b) the step of the flat arrangement of a flexible plastic part (3) between the multilayer film (2) and the pressure tool (4), with the result that in step b) the multilayer film (2) is pressed by the pressure tool (4) onto the hard plastic part (1) by means of the flexible plastic part (3).

3. Method according to claim 2, in which the flexible plastic part (3) is produced from silicone rubber.

4. Method according to claim 1, in which the pressure tool (4) is a glass sheet permeable for laser light.

5. Method according to claim 1, wherein the method is carried out under protective gas.

6. Composite, comprising a hard plastic part (1) and a multilayer film (2) connected flat to the hard plastic part (1), wherein the composite can be obtained according to the method according to claim 1.

7. Composite, comprising a hard plastic part (1) and a multilayer film (2), wherein the multilayer film (2) has a joint layer which contains an absorber for laser light, and wherein the multilayer film (2) is connected flat to the hard plastic part (1) such that the joint layer rests on the hard plastic part (1).

8. Composite according to claim 7, wherein the hard plastic part (1) is produced from a plastic selected from the group consisting of polyethylene, polypropylene, polyisoprene and their blends and copolymers, PET and also polycarbonates.

9. Composite according to claim 7, wherein the joint layer of the multilayer film (2) is produced from a material selected from the group consisting of polypropylene, polyethylene, polyisoprene, olefinic styrene block copolymers, their blends and copolymers thereof.

10. Composite according to claim 7, wherein the layers other than the joint layer of the multilayer film (2) are produced from one or more of polyamide and polyethylene terephthalate.

11. Composite according to claim 7, wherein the joint layer has a thickness of 10 to 100 μm.

12. Composite according to claim 7, wherein the absorber for laser light is selected from IR absorbers which absorb IR radiation in the range from 770-1000 nm.

13. Composite according to claim 7, wherein the absorber for laser light is present in the joint layer in a quantity of 50 to 100 ppm, relative to the weight of the joint layer.

14. Composite-welding array, comprising
a hard plastic part (1),
a multilayer film (2) which has a joint layer, wherein the multilayer film (2) is arranged flat on the hard plastic part (1) such that the joint layer rests on the hard plastic part (1), wherein the joint layer contains an absorber for laser light, and a pressure tool (4) permeable for laser light arranged on the multilayer film (2).

15. Composite-welding array according to claim 14, in which a flexible plastic part (3) is arranged flat between the multilayer film (2) and the pressure tool (4).

16. Composite-welding array according to claim 15, in which the flexible plastic part (3) is produced from silicone rubber.

17. Composite-welding array according to claim 14, in which the pressure tool (4) is a glass sheet permeable for laser light.

18. Composite-welding array according to claim 14, in which the multilayer film has an embossed structure.
